(19) United States
(12) Patent Application Publication
(10) Pub. No.: US 2007/0149021 A1
(43) Pub. Date: Jun. 28, 2007

(54) Harness and electronic apparatus

(75) Inventors: Masashi Mikami, Ome-shi (JP); Takao Tomoda, Hamura-shi (JP); Akihiko Uchida, Fussa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/602,408

(22) Filed: Nov. 21, 2006

(30) Foreign Application Priority Data
Dec. 22, 2005 (JP) 2005-369559

(51) Int. Cl. H01R 3/00

(52) U.S. Cl. 439/165

(57) ABSTRACT

A harness according to this invention comprises an electric cord, a first tape, and a second tape. The tapes are electrically conductive. The first tape has a first adhesive part adhered to the electric cord and two first overlapping parts spaced apart from the electric cord. The second tape has a shape corresponding to the shape of the first tape and has a second adhesive part adhered to the electric cord, and two second overlapping parts provided at ends of the second adhesive part, respectively, and firmly contact the first overlapping parts. The second adhesive part holds the electric cord in cooperation with the first adhesive part of the first tape.

### CROSS-REFERENCE TO RELATED APPLICATIONS

This application is based upon and claims the benefit of priority from Japanese Patent Application No. 2005-369559, filed Dec. 22, 2005, the entire contents of which are incorporated herein by reference.

### BACKGROUND

1. Field

One embodiment of the invention relates to electronic apparatus that has a harness, and to a harness that is designed to connect, for example, a display to the main unit of an electronic apparatus.

2. Description of the Related Art

Electronic apparatuses are known, each having a main unit, a display and a harness connecting the display to the main unit. Such electronic apparatus is disclosed in Jpn. Pat. Appln. KOKAI Publication No. 2002-237224. The harness has power lines, signal lines, and a ferrite core. The power lines supply power to the electronic circuits incorporated in the main unit and display. The signal lines transmit data to the electronic circuits. The ferrite core surrounds and shields the signal lines. The ferrite core is a magnetic member shaped like a hollow cylindrical. It has an axial hole, through which the signal lines extend. The ferrite core intercepts the electromagnetic waves generated from a signal line. Thus, the ferrite core protects the electronic circuits from electromagnetic disturbance.

If the space available for the harness is small, the harness may not have a ferrite core. Harnesses that have no ferrite cores and can yet intercept electromagnetic waves are known. Such a harness has electrically conductive tapes wound around the power lines and signal lines. The tapes intercept electromagnetic waves, each functioning as a conductive shield for the power line and signal lines. The tapes functioning as conductive shields are connected to one another, covering the power lines and signal lines, even if these lines are bent. Therefore, the electromagnetic waves emanating from the power lines and signal lines are prevented from reaching the electronic parts provided around the power lines and signal lines.

However, electromagnetic waves may leak at the junctions of the tapes functioning as shields. In this case, electromagnetic interference takes place, possibly imposing an adverse influence on the main unit or the display.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a portable computer according to an embodiment of this invention;

FIG. 2 is an exemplary perspective view of the harness incorporated in the housing of a portable computer shown in FIG. 1;

FIG. 3 is an exemplary exploded plan view showing the harness body of the harness shown in FIG. 2;

FIG. 4 is an exemplary sectional view of the harness, taken along line F4-F4 shown in FIG. 2;

FIG. 5 is an exemplary magnified sectional view of the harness shown in FIG. 4;

FIG. 6 is an exemplary exploded view explaining a step of manufacturing the harness shown in FIG. 2; and

FIG. 7 is an exemplary perspective view explaining a step of manufacturing of the harness, which step follows the step shown in FIG. 6.

### DETAILED DESCRIPTION

Various embodiments according to the invention will be described hereinafter with reference to the accompanying drawings. In general, according to one embodiment of the invention, a harness according to this invention comprises an electric cord, a first tape, and a second tape. The tapes are electrically conductive. The first tape has a first adhesive part adhered to the electric cord and two first overlapping parts spaced apart from the electric cord. The second tape has a shape corresponding to the shape of the first tape and has a second adhesive part adhered to the electric cord, and two second overlapping parts provided at ends of the second adhesive part, respectively, and firmly contact the first overlapping parts. The second adhesive part holds the electric cord in cooperation with the first adhesive part of the first tape.

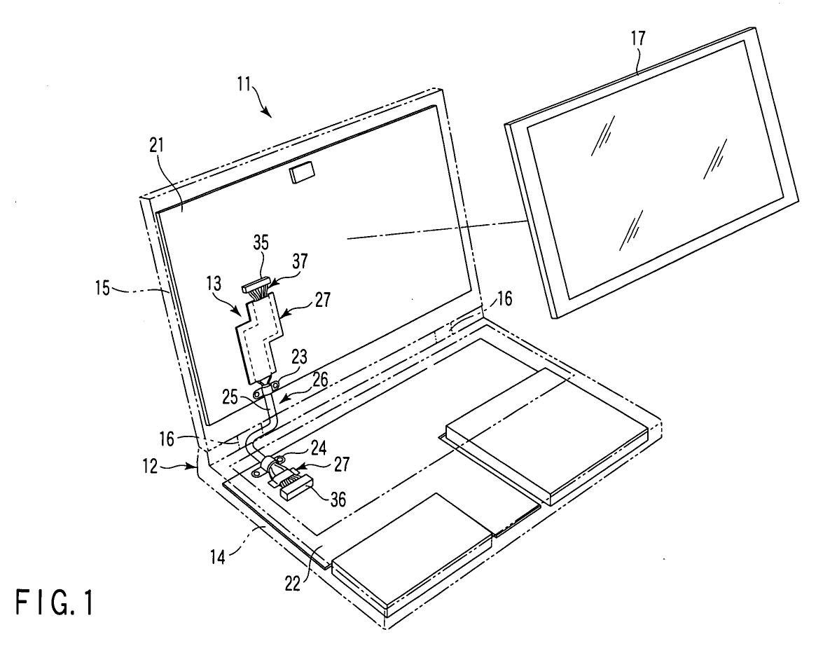

An electronic apparatus according to an embodiment of this invention, which a harness according to the present invention, will be described, with reference to FIGS. 1 to 7.

As shown in FIG. 1, a portable computer 11 that is an electronic apparatus according to this invention has a housing 12 and a harness 13. The harness 13 is provided in the housing 12. The housing 12 includes a first case 14, a second case 15, and a hinge mechanism 16. The hinge mechanism 16 is provided between the first case 14 and the second case 15. In other words, the harness 13 is positioned partly in the first case 14 and partly in the second case 15. The harness 13 extends from the first case 14 to the second case 15, passing through the hinge mechanism 16.

The second case 15 holds a display 17. The hinge mechanism 16 supports the second case 15, allowing the same to rotate freely around the first case 14. Thus supported by the hinge mechanism 16, the second case 15 can be opened and closed with respect to the first case 14.

The first ground layer 21 is provided on the inner surface of the second case 15. The first ground layer 21 is plated, for example. The second ground layer 22 is provided on the inner surface of the first case 14. The second ground layer 22 is plated, for example.

The harness 13 is secured to the first ground layer 21 by, for example, a first metal member 23. Similarly, the harness 13 is secured to the second ground layer 22, too, by a second metal member 24. The first and second ground layers 21 and 22 are electrically connected to each other by the third conductive tape 25 (described later) of the harness 13. The third tape 25 maintains the first ground layer 21 and second ground layer 22 at the same potential. A circuit board (not shown) is accommodated in the first case 14.

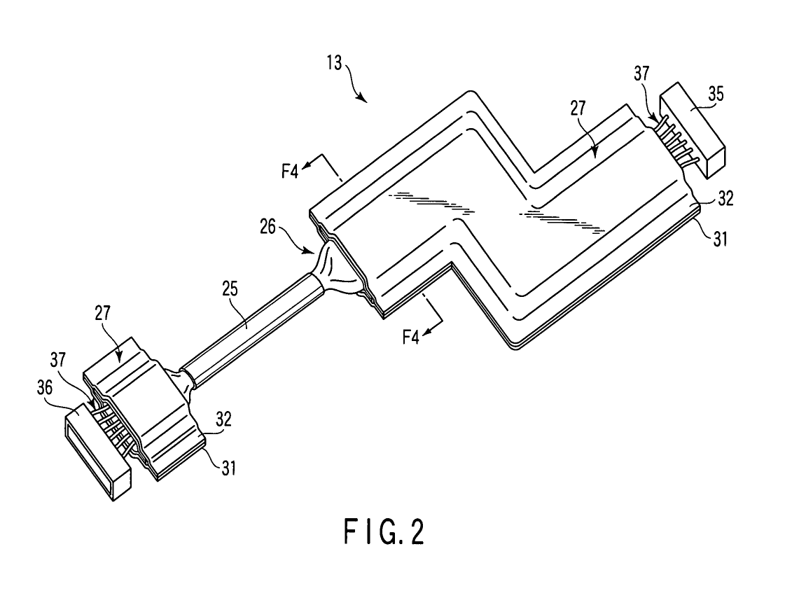

As shown in FIG. 2, the harness 13 has a harness body 26 and two insulating covers 27. The Insulating covers 27 cover the harness body 26. Each insulating cover 27 comprises a first insulating cover sheet 31 and a second insulating cover sheet 32. The sheets 31 and 32 are bonded to each other. Preferably, the first cover sheet 31 and the second cover sheet 32 are, for example, vinyl tapes.

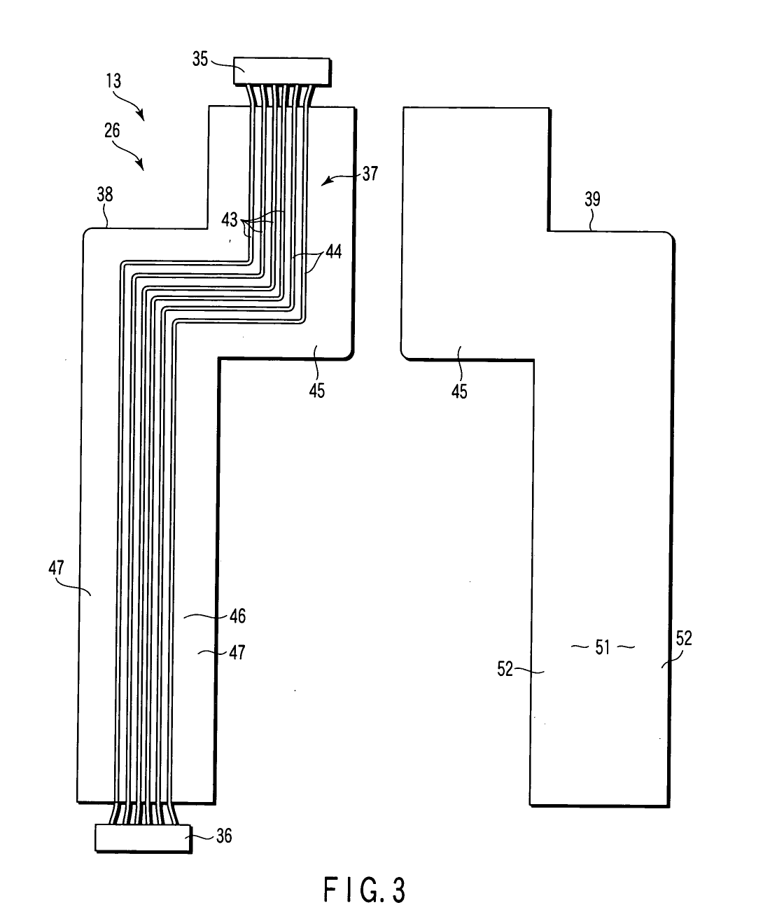

As FIGS. 2 and 3 show, the harness body 26 has a first connector 35, a second connector 36, an electric cord 37, a first tape 38, a second tape 39, and a third tape 25. The first connector 35 is connected to the display 17. The second connector 36 is connected to a male-type connector provided on the circuit board. The electric cord 37 connects the first and second connectors 35 and 36. The first tape 38 is adhered to the entire electric cord 37. The second tape 39 has a shape that is a mirror image to the first tape 38. The third tape 25 is wound around that part of the harness 13, which lies in the hinge mechanism 16.

The electric cord 37 includes signal lines 43 and power lines 44. The signal lines 43 are used to, for example, transmit signals between the first case 14 and the second case 15. The power lines 44 are used to supply power between the first case 14 and the second case 15. The electric cord 37 is bent in one plane, in the form of a crank. As FIG. 3 shows, the electric cord 37 has six lines, i.e., four signal lines 43 and two power lines 44. Nonetheless, the number of lines are not limited to six. The electric cord 37 may have, for example, two lines, ten lines or more lines.

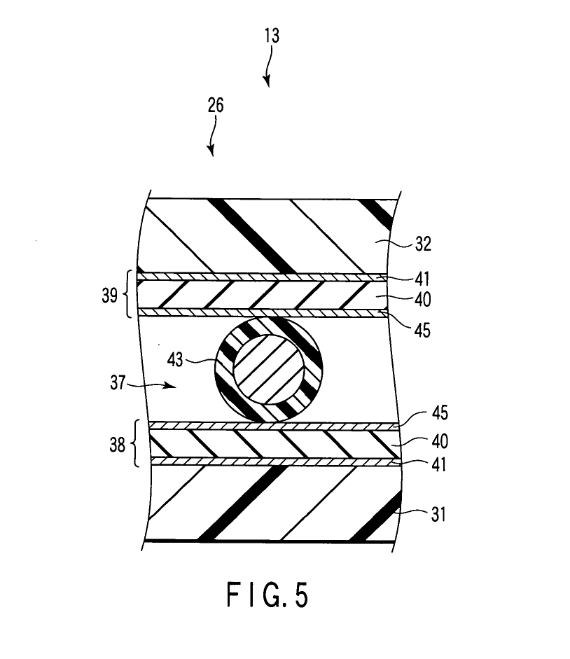

The first tape 38 has a shape corresponding to the shape of the electric cord 37. Like the electric cord 37, the first tape 38 is shaped like a crank in one plane. As FIG. 5 shows, the first tape 38 has a base layer 40, an adhesive layer 45, and a metal layer 41. The base layer 40 is made of cloth. The electric cord 37 holds the adhesive layer 45. The metal layer 41 has been formed by plating and is provided on the base layer 40. The metal layer 41 is made of, for example, copper, nickel, or the like. The metal layer 41 imparts some electrical conductivity to the first tape 38.

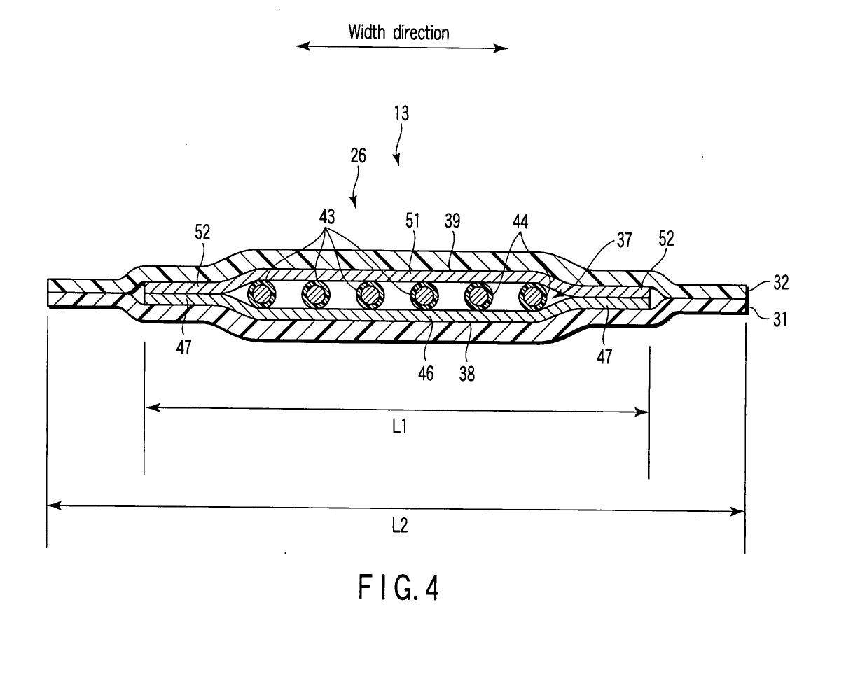

As FIG. 4 shows, the first tape 38 has a first adhesive part 46 and first overlapping parts 47. The first adhesive part 46 holds the entire electric cord 37. The first overlapping parts 47 are integrally formed with the ends of the first adhesive part 46. The first overlapping parts 47 are spaced apart from the electric cord 37 and are not adhered to the electric cord 37.

As FIG. 3 shows, the second tape 39 faces the first tape 38. The second tape 39 has a shape corresponding to the shape of the first tape 38. Its shape is a mirror image of the first tape 38. That is, the second tape 39 is shaped like a crank in one plane. As FIG. 5 shows, the second tape 39 has a base layer 40, a metal layer 41 and an adhesive layer 45, like the first tape 38. The metal layer 41 imparts some electrical conductivity to the second tape 39.

Being electrically conductive, the first and second tapes 38 and 39 intercept electromagnetic waves emanating from the electric cord 37. Therefore, no electromagnetic waves leak from the harness 13.

As shown in FIG. 4, the second tape 39 has a second adhesive part 51 and second overlapping parts 52. The second adhesive part 51 holds the electric cord 37. Thus, the electric cord 37 is interposed between the first tape 38 and the second tape 39. The second overlapping parts 52 are integrally formed with the ends of the second adhesive part 51. The second overlapping parts 52 are bonded to the first overlapping parts 47 of the first tape 38.

The first overlapping parts 47 and the second overlapping parts 52 have a width larger than the diameter of the electric cord 37. If the diameter of the electric cord 37 is 1 mm, the overlapping parts 47 and 52 may have a width of, for example, 5 to 10 mm. This prevents electric cord 37 from projecting through the gap between the first tape 38 and the second tape 39.

In the direction that intersects at right angles with the axial direction of electric cord 37, the width L2 of the first cover sheet 31 is greater width than the width L1 of the first tape 38. In that direction, the width L2 of the second cover sheet 32 is greater than width L1 of the second tape 39.

As shown in FIGS. 1, 2 and 6, the third tape 25 is wound around the first tape 38 and the second tape 39 that lie in the hinge mechanism 16. The third tape 25 is shaped like a hollow cylinder and covers the first tape 38 and the second tape 39.

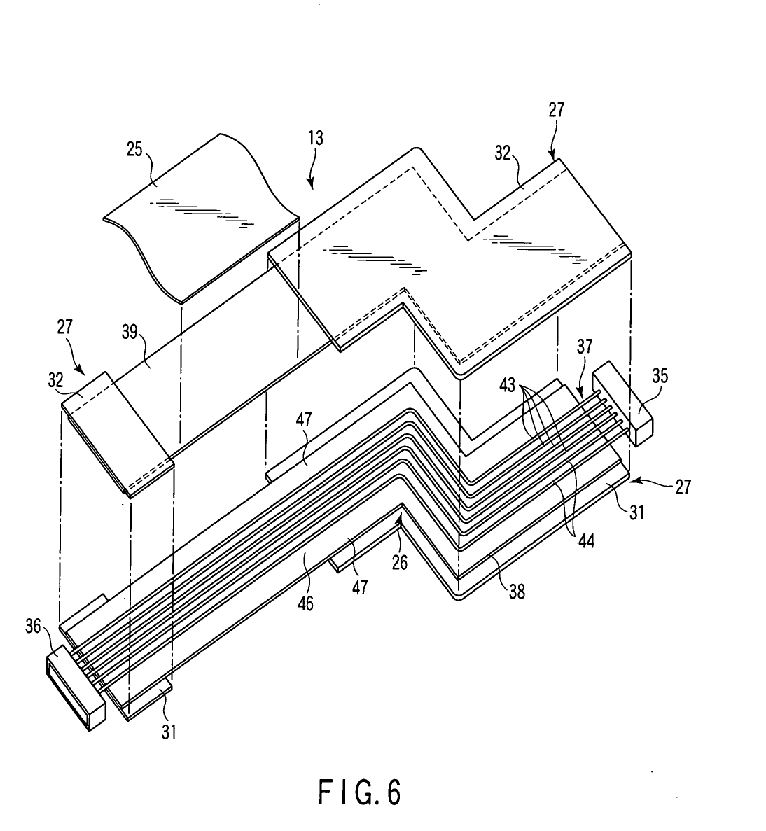

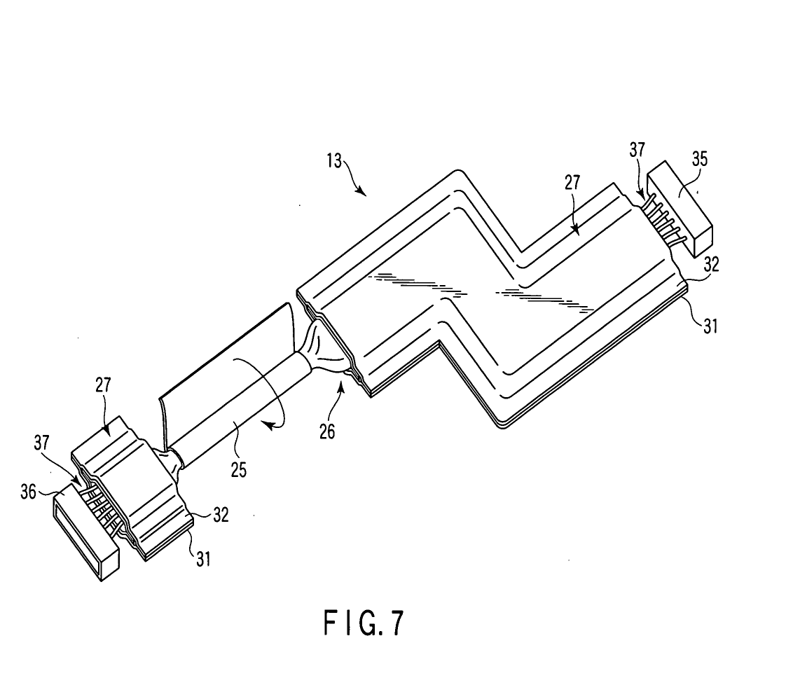

A method of manufacturing the harness 13 according to the embodiment will be explained with reference to FIG. 6 and FIG. 7. First, the first cover sheet 31 is bonded to that surface of the first tape 38, which faces away from the electric cord 37. Similarly, the second cover sheet 32 is bonded to that surface of the second tape 39, which faces away from the electric cord 37.

The second tape 39 is placed on the first tape 38. The tapes 38 and 39 are adhered to each other, with the electric cord 37 bonded to the second adhesive part 51 of the second tape 39 and the second overlapping parts 52 of the second tape 39 adhered to the first overlapping parts 47 of the first tape 38. Thus, the electric cord 37 is held between the first tape 38 and the second tape 39.

Next, the first cover sheet 31 and second cover sheet 32 are adhered to each other. The first cover sheet 31 and the second cover sheet 32, thus adhered to each other, constitute a bag-like insulating cover 27.

As shown in FIG. 1, FIG. 6, and FIG. 7, the third tape 25 is wound about to the first tape 38 and second tape 39, which will lie in the hinge mechanism 16. The third tape 25 is sufficiently long, extending from the first metal member 23 to the second metal member 24. Wound around the first tape 38 and second tape 39, the third tape 25 forms a hollow cylinder. A harness 13 is thus manufactured.

The portable computer 11, which is the first embodiment of the invention, has been described. In the embodiment, the peripheral surface of the electric cord 37 can be covered, without making a junction of the first tape 38 and the second tape 39. Note that the first tape 38 and second tape 39 are adhered to each other at their overlapping parts 47 and 52. Hence, the electromagnetic waves emanating from electric cord 37 are prevented from leaking at the junction of the first tape 38 and the second tape 39.

The first tape 38 and second tape 39 comprise a length of tape, each. Hence, harness 13 can be manufactured more easily than in the case where two or more tapes are connected. Further, the tapes 38 and 39 can be prevented from peeling from each other at the junction. Moreover, the harness 13 can be thin because it is composed of only the first tape 38 and second tape 39 adhered to each other. If the harness 13 is thin, it will not interfere with the second case 15 or a circuit board.

Electric cord 37 and the first tape 38 are beforehand pasted up by the first adhesive part 46. Thereby, the manufacturing process of harness 13 can be simplified.

The first tape 38 and the second tape 39 are made of cloth and plated on the surfaces. These tapes 38 and 39 therefore have a sufficient mechanical strength. This helps to enhance the mechanical strength of the harness 13.

As described above, the harness 13 has the first cover sheet 31 and the second cover sheet 32. The first cover sheet 31 is adhered to that surface of the first tape 38 which faces away from the electric cord 37, and the second cover sheet 32 is adhered to that surface of the second tape 39 which faces away from the electric cord 37. Therefore, there is no possibility that the first tape 38 and second tape 39 that have conductivity may short-circuit with other electronic parts in portable computer 11. Since the first cover sheet 31 and the second cover sheet 32 have been bonded to the first tape 38 and the second tape 39, respectively, they can be adhered to each other when the first tape 38 and the second tape 39 are adhered to each other. This serves to simplify the manufacture of the harness 13.

The first cover sheet 31 is boarder than the first tape 38, and the second cover sheet 32 is broader than the second tape 39. For this reason, the first tape 38 does not protrude from the first cover sheet 31, and the second tape 39 does not protrude from the second cover sheet 32. There is no possibility that the first tape 38 and second tape 39 may contact any electronic components to cause short-circuit.

As indicated above, the harness 13 has the third tape 25. The third tape 25 is electrically conductive and wrapped around those parts of the first tape 38 and second tapes 39, which lie in the hinge mechanism 16. The third tape 25 can therefore increase the mechanical intensity of the harness 13. Note that the harness 13 is repeatedly bent at the hinge mechanism 16 as the second case 15 is repeatedly opened and closed. Since the third tape 25 is provided in hinge mechanism 16, it prevents the first tape 38 and second tape 39 from being separated from each other in the hinge mechanism 16. Further, the third tape 25 connects the first ground layer 21 and the second ground layer 22. Namely, these ground layers 21 and 22 are fastened together by a conductive member, or a low-resistance member. Once the first and second ground layers 21 and 22 have been so connected, electromagnetic noise will not be amplified between the first case 14 and the second case 15.

In the embodiment, the harness 13 has the insulating cover 27. Nevertheless, this cover 27 can be dispensed with if the harness 13 is used in an electronic apparatus wherein no short-circuit takes place. The first cover sheet 31 has been already bonded to the first tape 38 when the first tape 38 and the second tape 39 are adhered together. Instead, it may be adhered to the first tape 38 after the tapes 38 and 39 have been adhered together. Similarly, the second cover sheet 32 may be adhered to the second tape 39 after the tapes 38 and 39 have been adhered together.

Assume that the third tape 25 is not used at all. In this case, the first tape 38 and the second tape 39 can perform the function of the third tape 25 only if that part of, for example, the first tape 38, which lies in the hinge mechanism 16, is made broader, providing an extra part that corresponds to the third tape 38. After the first tape 38 and the second tape 39 are adhered to each other, the extra part is wound around the second tape 39, forming a hollow cylinder. Then, the harness 13 will perform its function well, without the third tape 25.

The shape of the first tape 38 and the second tape 39 is not limited to the crank shape that is shown in FIG. 3. In the embodiment, the first tape 38 and second tape 39 are shaped like a crank. Nonetheless, the second tape 39 may have any other shape corresponding to that of the first tape 38. That is, if the electric cord 37 extends straight, the first tape 38 and second tape 39 may be rectangular, extending parallel to the electric cord 37. If the electric cord 37 is sharply bend at several parts and has several crank-shaped parts, the first tape 38 and second tape 39 may have crank-shaped parts, too. If the electric cord 37 is gently waved at several parts, the first tape 38 and second tape 39 may be wave-shaped, too.

The harness 13 according to this invention can be used not only to the portable computer described above, but also to other electronic apparatus such as personal digital assistants (PDAs). The second case 15 can rotate in the embodiment. Nevertheless, the harness 13 can be used also in an electronic apparatus in which the component equivalent to the second case 15 cannot rotate at all.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A harness comprising:
an electric cord;
a first tape which is electrically conductive, which has a shape corresponding to the shape of the electric cord and which has a first adhesive part adhered to the electric cord and two first overlapping parts provided at ends of the first adhesive part, respectively, and spaced apart from the electric cord; and
a second tape which is electrically conductive, which has a shape corresponding to the shape of the first tape and which has a second adhesive part adhered to the electric cord, and two second overlapping parts provided at ends of the second adhesive part, respectively, and firmly contact the first overlapping parts, the second adhesive part holding the electric cord in cooperation with the first adhesive part of the first tape.

2. The harness according to claim 1, wherein the electric cord and the first tape are adhered beforehand at the first adhesive part.

3. The harness according to claim 1, wherein the first tape and the second tape are made of cloth and plated on surfaces.

4. The harness according to claim 1, further comprising:
a first cover sheet which is adhered to that surface of the first tape which faces away from the electric cord; and
a second cover sheet which is adhered to that surface of the second tape which faces away from the electric cord.

5. The harness according to claim 4, wherein the first cover sheet is broader than the first tape, and the second cover sheet is broader than the second tape.

6. An electronic apparatus comprising a housing and a harness provided in the housing, said harness comprising:
an electric cord;
a first tape which is electrically conductive, which has a shape corresponding to the shape of the electric cord and which has a first adhesive part adhered to the electric cord and two first overlapping parts provided at ends of the first adhesive part, respectively, and spaced apart from the electric cord; and
a second tape which is electrically conductive, which has a shape corresponding to the shape of the first tape and which has a second adhesive part adhered to the electric cord, and two second overlapping parts provided at ends of the second adhesive part, respectively, and firmly contact the first overlapping parts, the second adhesive part holding the electric cord in cooperation with the first adhesive part of the first tape.

7. The electronic apparatus according to claim 6, wherein the housing comprises:
a first case;
a second case; and
a hinge mechanism which is provided between the first case and the second case and which supports the second case, enabling the second case to rotate freely, and
the harness is positioned partly in the first case and partly in the second case.

8. The electronic apparatus according to claim 7, wherein the harness further comprises a third tape which is electrically conductive and which covers those parts of the first tape and second tape which lie in the hinge mechanism.
